(19) United States
(12) Patent Application Publication
(10) Pub. No.: US 2007/0028699 A1
(43) Pub. Date: Feb. 8, 2007

(54) Pressure sensor

(76) Inventors: Jian Chen, Heist-op-den Berg (BE); Appolonius Jacobus Van Der Wiel, Tervuren (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/563,444

(22) PCT Filed: Jul. 2, 2004
(86) PCT No.: PCT/IB04/02197

§ 371 Date: May 15, 2006

(30) Foreign Application Priority Data
Jul. 2, 2003 (GB) 0315489.5

(51) Int. Cl. G01L 9/00

(52) U.S. Cl. 73/754

(57) ABSTRACT

A pressure sensor 100 suitable for being fitted to or embedded in a tyre comprises an integrated circuit 101 mounted on a lead frame 102, the integrated circuit 101 incorporating a pressure sensing element. A gel blob 103 covers the pressure sensing element of the integrated circuit 101. The integrated circuit 101, lead frame 102 and gel blob 103 are encapsulated within a plastic moulded package 104. An opening 106 is provided in the plastic package 104 through which the gel blob 103 is exposed to the atmosphere. The gel blob 103, being flexible is able to transfer the pressure of the atmosphere to the pressure sensing element. A filter 105 covers the opening 106 in order to prevent the ingress of water or harmful substances into the aperture. In alternative embodiments, the gel blob 103 may be removed.

The present invention relates to pressure sensor and in particular to a pressure sensor adapted to be fitted to or embedded in automotive tyres.

TPMS (Tyre Pressure Monitoring Systems) are in time expected to become standard fittings on all new passenger cars in all market areas. They provide an essential safety feature since under-inflated tyres can cause severe handling and performance limitations and thereby lead to accidents on the road. A typical TPMS comprises a pressure sensor located in a tyre operative to sense the pressure within the tyre and transmit Radio Frequency (RF) signals to a receiver located on the body of a vehicle. Information contained in the signals is then transferred to the vehicles display systems in order that the vehicles driver may be alerted to the tyre pressure.

In order to operate in such an environment the pressure sensor should be small, light, capable of withstanding high centrifugal force, capable of surviving in a harsh environment (fuel and other chemicals may be present in the tyre) and be low cost with a long lifespan (˜10 years). A conventional pressure sensor design with most of these characteristics comprises an integrated circuit with a pressure sensing element encapsulated within a protective package. Whilst this provides some measure of protection for the sensor, an opening must still be provided in the package to permit pressure sensing. The provision of such an opening however allows the potential ingress of harmful chemicals into the package, and may thus damage the sensing element.

In order to prevent harmful chemical ingress, conventional sensors include a gel covering over the pressure sensing element offering a protective coating to the pressure sensing element whilst still transmitting the pressure to the pressure sensing element. There are however two potential problems with this solution. Firstly, the gel has a mass, and under the influence of the accelerations experienced by the tyre, both centrifugal and lateral acceleration, the mass generates forces which can be transferred to the pressure sensing element and thereby introduce errors into the pressure recorded by the sensing element. Secondly, the gel can become detached from the surface of the sensing element and thus allow moisture and or potentially corrosive chemicals to come into contact with the pressure sensing element and or the surface of the integrated circuit. Such contact could cause damage to the sensing element and or the integrated circuit.

It is therefore an object of the present invention to provide an improved pressure sensor.

According to a first aspect of the present invention there is provided a pressure sensor comprising an integrated circuit encapsulated within a package, said integrated circuit including a pressure sensing element, an opening being provided in the package allowing the pressure sensor to be exposed to the atmosphere wherein a filter extends across the opening thereby preventing the ingress of moisture or other harmful substances.

Preferably, the integrated circuit incorporates a radio frequency transponder or other means for connecting or transmitting the output of the pressure sensing element to external circuitry.

Preferably, the filter is fixed to the surface of the package such that it extends over and covers the opening. The filter is preferably comprised of a substance suitable to ensure harmful material is filtered out by the filter. Preferably, the substance is chosen to have such characteristics as to optimize its performance in the application.

Preferably, the filter is a membrane or film, most preferably an organic film or membrane and particularly preferably, the filter is in the form of a membrane such as those manufactured by Donaldson Company Inc of Minneapolis, Minn. USA.

Preferably, the sensor is adapted to be fitted to or embedded in a vehicle tyre.

Preferably the integrated circuit is mounted on a lead frame or similar which may, if desired, be completely encapsulated within the package.

Preferably, the package is a conventional semiconductor package incorporating an opening. The package may be formed from any suitable material but is preferably a plastic.

The opening may be wholly filled or partially filled with gel, if desired. If the opening is wholly filled or partially filled with gel, the gel chosen is preferably a relatively soft gel of relatively low density in order to provide a good transfer of atmospheric pressure to the sensing element whilst minimizing the forces applied to the sensing element by the gel during motion of the tyre.

The package incorporating the opening is preferably formed by applying a blob of gel to the integrated circuit such that it covers at least the pressure sensing element of the integrated circuit to form a gel coated assembly, placing the assembly into a moulding tool such that the gel blob is in contact with the surface of the moulding tool and encapsulating the assembly in a suitable moulding material. After the moulding process is complete, the gel may be removed if desired. The filter is then preferably affixed to the package so that it covers the opening once the moulding process is complete. In embodiments wherein the gel is removed, the filter is preferably affixed to the passage so that it covers the opening once the gel is removed, after the completion of the moulding process.

Of course, the package incorporating an opening may be manufactured by any other standard technique used to manufacture encapsulated integrated circuits,

The gel used to manufacture the package may be selected so as to have characteristics which to reduce or eliminate the effects of the mass of the gel on the pressure sensitive area of the sensor or enable the gel to be easily removed from the cavity before the filter is applied. In embodiments wherein the gel is removed, problems caused by the detachment of the gel blob from the pressure sensing element are eliminated. The gel can therefore be a low cost, fast-cure gel. Alternatively, in embodiments wherein the gel fills or partially fills the opening, the dimensions of the opening need not be arranged to prevent the gel blob from falling out of the opening, as the filter will perform this function. Thus, in either embodiment, the gel application is much easier and less time consuming.

According to a second aspect of the present invention there is provided a method of manufacturing a pressure sensor comprising the steps of: providing an integrated circuit, the integrated circuit incorporating a pressure sensing element; applying a quantity of gel to the integrated circuit such as to cover at least the sensing element, thereby forming a gel-covered assembly; inserting the gel-covered assembly into a cavity of a moulding tool, said assembly being positioned such that a portion of said gel is in contact with the surface of the moulding tool; introducing a moulding compound into the cavity so as to encapsulate the assembly except for the portion of gel in contact with the moulding tool; removing the assembly from the cavity, whereby there is an opening defined in the package encapsulating the coated assembly through which the active element may be exposed to external air pressure; and affixing a suitable filter to the surface of the package such that the filter extends across the opening thereby preventing the ingress of moisture or other harmful substances.

The method of the second aspect of the present invention may be used to manufacture sensors according to the first aspect of the present invention and may incorporate any features of the first aspect of the invention as desired or appropriate.

Preferably, the integrated circuit is mounted on a suitable lead frame before encapsulation. Preferably, a projection is provided on the surface of the moulding tool adapted to make contact with the gel. Alternatively, the projection may be a removable pin.

A number of embodiments of the invention will now be described further herein, by way of example only, and with reference to the accompanying drawings in which:—

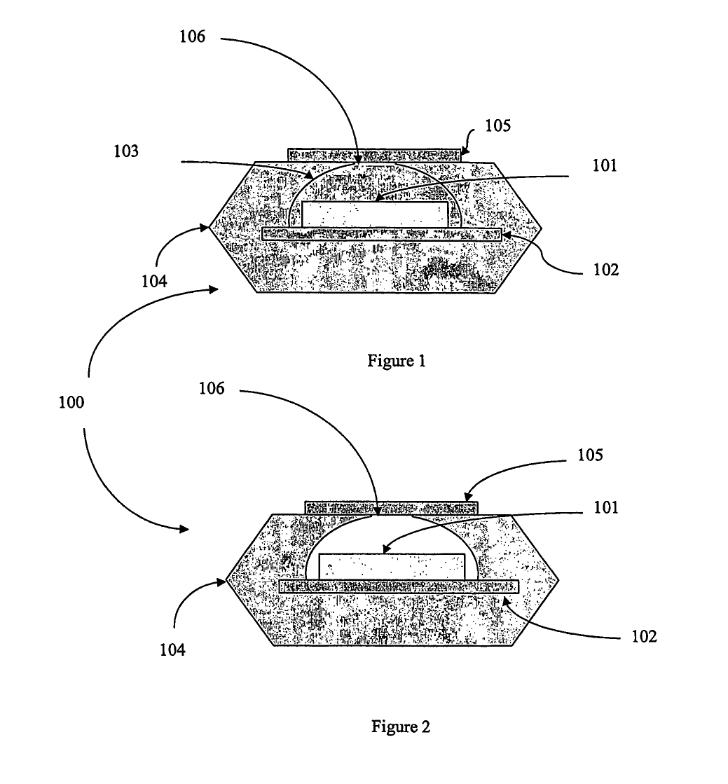

FIG. 1 shows a cross-section of a pressure sensor according to the present invention; and

FIG. 2 shows a cross-section of an alternative pressure sensor according to the present invention.

Referring to FIG. 1, a pressure sensor 100 suitable for being fitted to or embedded in a tyre comprises an integrated circuit 101 mounted on a lead frame 102, the integrated circuit 101 incorporating a pressure sensing element. A gel blob 103 covers the pressure sensing element of the integrated circuit 101. The integrated circuit 101, lead frame 102 and gel blob 103 are encapsulated within a plastic moulded package 104.

An opening 106 is provided in the plastic package 104 through which the gel blob 103 is exposed to the atmosphere. The gel blob 103, being flexible is able to transfer the pressure of the atmosphere to the pressure sensing element. In order to maximise performance the gel 103 is soft and of low density so that air pressure is transferred accurately to the sensing element but forces generated by the gel 103 pressing against the sensing element during motion are minimized.

A filter 105 covers the opening 106 in order to prevent the ingress of water or harmful substances into the aperture. The filter 105 is securely fixed to the package 104. This can be achieved by welding, adhesive or any other suitable means.

The filter is comprised of an organic membrane such those manufactured by Donaldson Company Inc of Minneapolis, Minn. USA.

Additional electronic or electrical components (not shown) are also mounted on or connected to the lead frame 102. The lead frame 102 may be formed of electrically non-connected sections if required. The additional components provide additional functionality in the device and may include a radio frequency transponder or other means for transmitting or connecting the pressure sensing element to external circuitry.

In use, the pressure senor 100 is fitted to or embedded in a vehicle tyre. It is operative to sense the pressure of the tyre and transmit information on the pressure of the tyre to external circuitry provided in the vehicle or elsewhere.

The sensor 100 is manufactured by the following technique. The integrated circuit 101 is manufactured and connected to the lead frame 102 in a conventional manner. A gel blob 103 is then applied to at least the pressure sensitive area of the integrated circuit 101 to form a gel coated assembly, the gel 103 being subsequently cured.

The assembly is then inserted into a moulding tool. The volume of the gel blob 103 applied is chosen and regulated such as to ensure the gel 103 touches the side of the moulding tool. The assembly is then encapsulated in a suitable packaging material to form a packaged device 104. Because the gel 103 touches the side of the tool during the moulding process, the moulded package 104 contains an opening 106 through which the gel blob 103 can be exposed to the atmosphere. In this manner pressure is transferred from the gel 103 to the pressure sensing element of the integrated circuit 101 from the atmosphere outside the package 104.

A filter 105 is then affixed to the surface of the package 104 to cover the opening. The filter 105 helps to prevent the ingress of moisture, particulate matter or other harmful substances.

In alternative methods of manufacturing the invention the gel blob 103 may be in contact with a pin or other projection from the side of the moulding tool in order to ensure that an opening 106 in the moulded package 104 is provided. Further suitable methods of forming the package 104 may be used alternatively, if desired.

FIG. 2 shows an alternative embodiment of the invention wherein the pressure sensor 100 is manufactured in the same manner as above wherein no gel blob is provided in the opening of the completed pressure sensor 100. A sensor of this type is manufactured by incorporating the additional step of removing the gel blob 103 from the opening 106 prior to the attachment of the filter 105. Removing the gel blob 103 can reduce errors in the pressure measurement caused by acceleration and other inertial forces transferred by the gel blob 103 to the pressure sensing element when in motion. In such embodiments, the gel 103 is chosen so that it is easily removable from the opening 106.

It is of course to be understood that the invention is not to be restricted to the details of the above described embodiments which are described by way of example only.

1. A pressure sensor comprising an integrated circuit encapsulated within a package, said integrated circuit including a pressure sensing element, an opening being provided in the package allowing the pressure sensor to be exposed to the atmosphere wherein a filter extends across the opening thereby preventing the ingress of moisture or other substances.

2. A pressure sensor as claimed in claim 1 wherein the integrated circuit incorporates a radio frequency transponder or other means for connecting or transmitting the output of the pressure sensing element to external circuitry.

3. A pressure sensor as claimed in claim 1 wherein the filter is fixed to the surface of the package such that it extends over and covers the opening.

4. A pressure sensor as claimed in claim 1 wherein the filter is a membrane or film.

5. A pressure sensor as claimed in claim 4 wherein the filter is an organic film or membrane.

6. A pressure sensor as claimed in claim 1 wherein the sensor is adapted to be fitted to or embedded in a vehicle tyre.

7. A pressure sensor as claimed in claim 1 wherein the integrated circuit is mounted on a lead frame.

8. A pressure sensor as claimed in claim 7 wherein the integrated circuit and the lead frame are completely encapsulated within the package.

9. A pressure sensor as claimed in claim 1 wherein the package is a conventional semiconductor package incorporating an opening.

10. A pressure sensor as claimed in claim 1 wherein the package is plastic.

11. A pressure sensor as claimed in claim 1 wherein the opening is wholly filled with gel.

12. A pressure sensor as claimed in claim 1 wherein the opening is partially filled with a gel.

13. A pressure sensor as claimed in claim 11 wherein the gel is a relatively soft gel of relatively low density.

14. A method of manufacturing a pressure sensor comprising the steps of: providing an integrated circuit, the integrated circuit incorporating a pressure sensing element; applying a quantity of gel to the integrated circuit such as to cover at least the sensing element, thereby forming a gel-covered assembly; inserting the gel-covered assembly into a cavity of a moulding tool, said assembly being positioned such that a portion of said gel is in contact with the surface of the moulding tool; introducing a moulding compound into the cavity so as to encapsulate the assembly except for the portion of gel in contact with the moulding tool; removing the assembly from the cavity, whereby there is an opening defined in the package encapsulating the coated assembly through which the pressure sensing element may be exposed to external air pressure; and affixing a suitable filter to the surface of the package such that the filter extends across the opening thereby preventing the ingress of moisture or other harmful substances.

15. A method of manufacturing a pressure sensor as claimed in claim 14 wherein the integrated circuit is mounted on a suitable lead frame before encapsulation.

16. A method of manufacturing a pressure sensor as claimed in claim 14 wherein the gel is removed from the sensing element after encapsulation but before the filter is affixed.

17. A method of manufacturing a pressure sensor as claimed in claim 16 wherein the gel is a low cost, fast-cure gel.

18. A method of manufacturing a pressure sensor as claimed in claim 14 wherein the filter is affixed by means of a suitable adhesive.

19. A method of manufacturing a pressure sensor as claimed in claim 14 wherein a projection is provided on the surface of the moulding tool adapted to make contact with the gel.

20. A method of manufacturing a pressure sensor as claimed in claim 19 wherein the projection is a removable pin.

21. A pressure sensor manufactured according to the method of claim 14.
